(19) United States
(12) Patent Application Publication
(10) Pub. No.: US 2013/0246825 A1
(43) Pub. Date: Sep. 19, 2013

(54) METHOD AND SYSTEM FOR DYNAMICALLY POWER SCALING A CACHE MEMORY OF A MULTI-CORE PROCESSING SYSTEM

(71) Applicant: Christopher John Shannon, Rolling Meadows, IL (US)

(72) Inventor: Christopher John Shannon, Rolling Meadows, IL (US)

(73) Assignee: RESEARCH IN MOTION LIMITED, Waterloo, ON (CA)

(21) Appl. No.: 13/635,361

(22) PCT Filed: Mar. 25, 2011
(86) PCT No.: PCT/US11/29981

§ 371 Date: Sep. 14, 2012

(51) Int. Cl. G06F 1/32; G06F 12/08

(52) U.S. Cl. CPC G06F 1/3275; G06F 12/084
USPC 713/324

(57) ABSTRACT

A system and method of power scaling cache memory (110) of a multi-core processing system includes a plurality of core processors (100), a cache memory (110) and a controller (125). The cache memory (110) includes partitioned cache (120) and shared cache (115). The shared cache (115) can be partitioned into the partitioned cache (120). Each core processor (100) is communicatively coupled to at least one corresponding partitioned cache (120) and the shared cache (100). The controller (125) is communicatively coupled to each of the core processors (100), to the partitioned cache (120), and to the shared cache (115). The controller (125) is configured to cause the at least one corresponding partitioned cache (120) to power down in response to the corresponding core processor (100) powering down. The controller (125) can also be configured to flush the cache lines of the partitioned cache (125) prior to powering down the partitioned cache (125) in response to the corresponding processor (100) powering down.

### FIELD OF TECHNOLOGY

The instant disclosure relates generally managing cache memory of processing system. More specifically, the instant disclosure relates to a method and system for dynamically power scaling a cache memory of a multi-core processing system.

### BACKGROUND

With the advent of more robust electronic systems, advancements of electronic devices are becoming more prevalent. Electronic devices can provide a variety of functions including, for example, telephonic, audio/video, and gaming functions. Electronic devices can include mobile stations such as cellular telephones, smart telephones, portable gaming systems, portable audio and video players, electronic writing or typing tablets, mobile messaging devices, personal digital assistants, and handheld computers. Additionally, as electronic devices advance, the size and capabilities of the processing system must also advance without compromising the power consumption.

### BRIEF DESCRIPTION OF THE DRAWINGS

Implementations of the instant disclosure will now be described, by way of example only, with reference to the attached Figures, wherein:

FIG. 1 is a block diagram of a system for dynamically power scaling a cache memory of a multi-core processing system in accordance with an example implementation of the present technology, where a controller is integrated with each core processor;

FIG. 2 is a block diagram of a system for dynamically power scaling a cache memory of a multi-core processing system in accordance with another example implementation of the present technology, where a controller is communicatively coupled to the core processors and the cache memory;

FIG. 3 a flow chart of a method of dynamically power scaling a cache memory of the multi-core processors and the cache memory in accordance with an example implementation of the present technology;

FIG. 4 is a block diagram of a system for dynamically power scaling a cache memory of a multi-core processing system in accordance with an example implementation of the present technology, illustrating the logical path for read and allocate actions of the system;

FIG. 5 is an illustration of the logical path for flushing a partitioned cache of a system for dynamically power scaling a cache memory of a multi-core processing system in accordance with an example implementation of the present technology;

FIG. 6 is an illustration of an example electronic device in which a system for dynamically power scaling a cache memory of a multi-core processing system can be implemented; and

FIG. 7 is a block diagram representing an electronic device comprising a system for dynamically power scaling a cache memory of a multi-core processing system and interacting in a communication network in accordance with an example implementation of the present technology.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example implementations described herein. However, it will be understood by those of ordinary skill in the art that the example implementations described herein may be practiced without these specific details. In other instances, methods, procedures and components have not been described in detail so as not to obscure the implementations described herein. Also, the description is not to be considered as limiting the scope of the implementations described herein.

Several definitions that apply throughout this disclosure will now be presented. The word “coupled” is defined as connected, whether directly or indirectly through intervening components, and is not necessarily limited to physical connections. The term “communicatively coupled” is defined as connected, whether directly or indirectly through intervening components, is not necessarily limited to a physical connection, and allows for the transfer of data. The term “electronic device” is defined as any electronic device that is at least capable of accepting information entries from a user and includes the device's own power source. A “wireless communication” means communication that occurs without wires using electromagnetic radiation. The term “memory” refers to transitory memory and non-transitory memory. For example, non-transitory memory can be implemented as Random Access Memory (RAM), Read-Only Memory (ROM), flash, ferromagnetic, phase-change memory, and other non-transitory memory technologies. The term “mobile device” refers to a handheld wireless communication device, a handheld wired communication device, a personal digital assistant (PDA) or any other device that is capable of transmitting and receiving information from a communication network.

Conventional multi-core processing systems can have each core processor powered down through software or hardware mechanisms based on the changing software workload to that particular core processor. For example, in such conventional multi-core processing systems, the individual cores can dynamically switch between a busy state and idle state, thereby conserving power. In other conventional multi-core processing systems, a shared cache is implemented and shared by a number of the core processors. However, while one of the core processors can power down, the shared cache will typically not power down. Although the shared cache is effectively larger for utilization by the remaining cores that are not powered down, the shared cache still consumes unnecessary power. Accordingly, the present technology provides a system for dynamically power scaling a cache memory of a multi-core processing system.

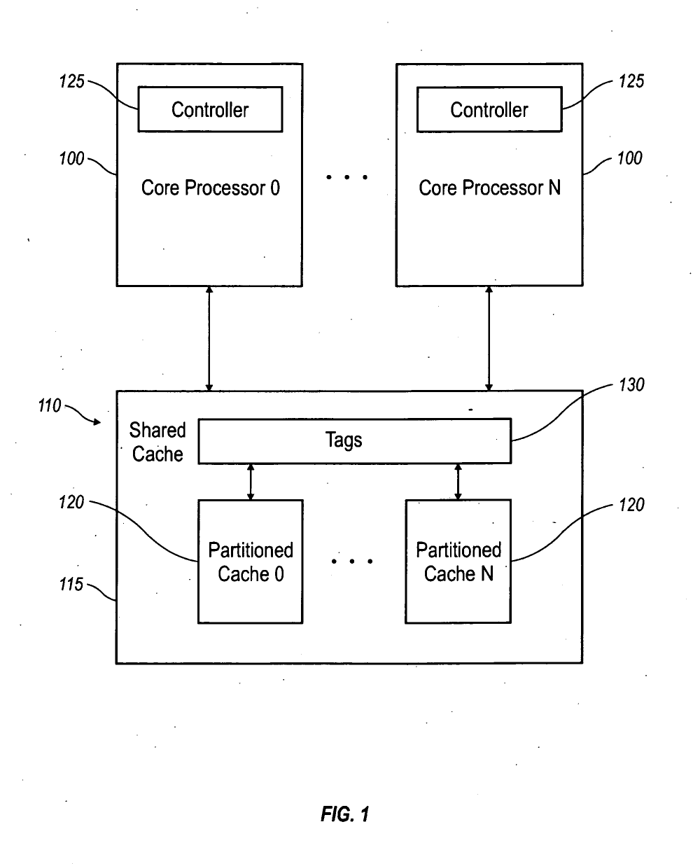

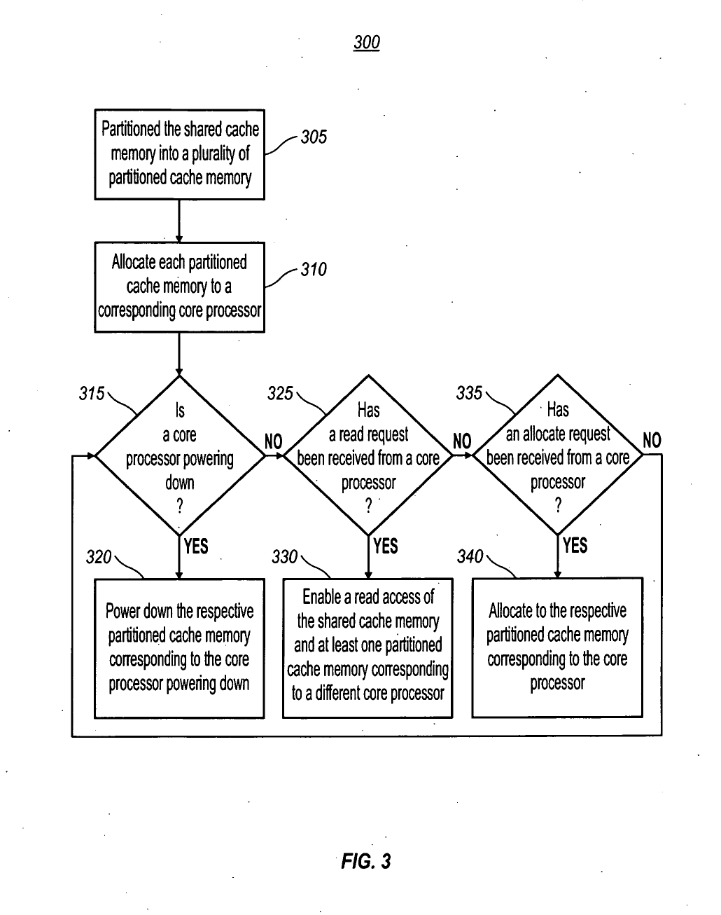

FIG. 1 illustrates an example implementation of the system for dynamically power scaling a cache memory of a multi-core processing system. In FIG. 1, the system includes a plurality of core processors 100 and a cache memory 110. The cache memory 110 includes partitioned cache 120 and shared cache 115. Each core processor 100 can be communicatively coupled to at least one corresponding partitioned cache 120 and the shared cache 115. In at least one implementation, the shared cache 115 can be partitioned into partitioned cache 120. For example, the partitioned cache 120 can be a portion of the shared cache 115, as illustrated in FIG. 3.

The system can also include a controller 125. The controller 125 can be communicatively coupled to each of the core processors 100, to the partitioned cache 120, and to the shared cache 115. In the example implementation illustrated in FIG. 1, each core processor 100 has a respective controller 125 coupled thereto. Each controller 125 is communicatively coupled to the shared cache 115 and the partitioned cache 120. The controller 125 is configured to cause the at least one corresponding partitioned cache 120 to power down in response to the corresponding core processor 100 powering down. The controller 125 can also be adapted to flush the partitioned cache 120 prior to powering down the partitioned cache 120. In other example implementations, the controller 125 can be configured to enable a read action and a write action for each of the core processors 100. For example, the read action can enable the core processor 100 to read and retrieve data stored on cache memory 110. The data can be stored: on the shared cache 115, the corresponding partitioned cache 120 associated with the core processor 100 requesting the read action (e.g., the requesting core processor), or the corresponding partitioned cache 120 associated with a core processor 120 different form the core processor requesting the read action. A write action can enable the core processor 100 to write or store data on the corresponding partitioned cache 120 associated with the core processor 100 requesting the write action. In at least one example implementation, each partitioned cache 120 is “owned” by its respective corresponding core processor 100. For example, each partitioned cache 120 can be allocated or written to by only its respective corresponding core processor 100, while the partitioned cache 120 can be read by any or all of the core processors 100, including core processors 120 different from the respective corresponding core processor 100 of the partitioned cache 120.

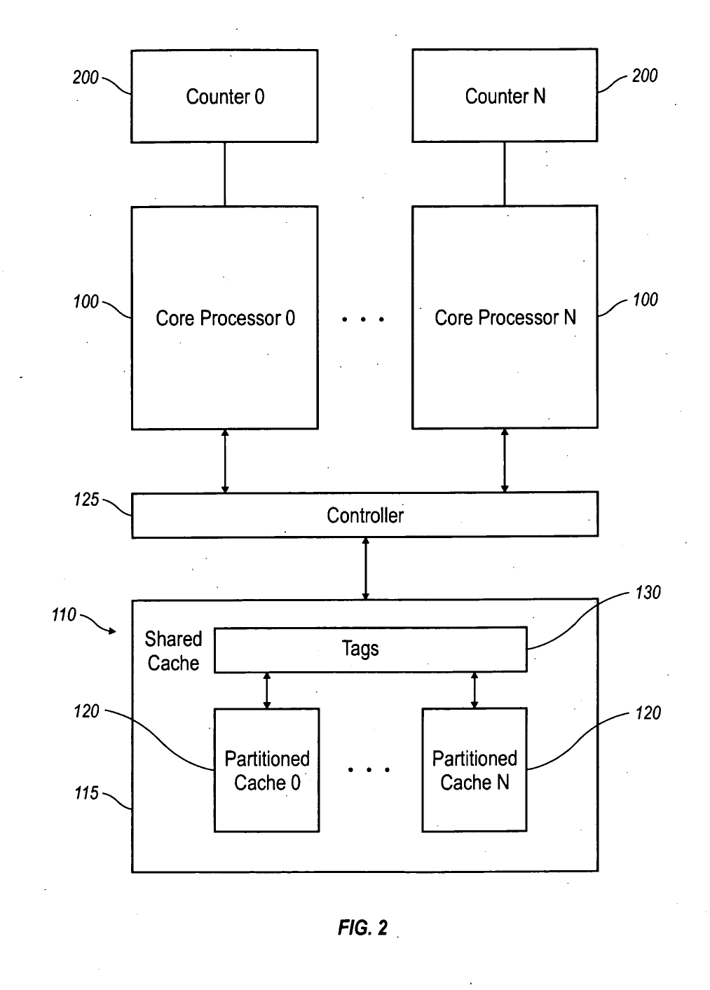

While FIG. 1 illustrates a controller 125 integrated into each of the core processors 100, those of ordinary skill in the art will appreciate that the controller 125 can be communicatively coupled to each of the core processors 100. For example, a single controller 125 can be implemented, as illustrated in FIG. 2. In such an implementation, the controller 125 is communicatively coupled to each of the core processors 100 and the cache memory 110. In other example implementations, the controller 125: can be integrated with the cache memory 110; can be a plurality of controllers 125 each separate from an communicatively coupled to a core processor 120; can be a plurality of controllers 125 each separate from and communicatively coupled to a partitioned cache 120; or any other arrangement which allows the controller 125 to be communicatively coupled to each of the core processors 100, the partitioned cache 120, and the shared cache 115.

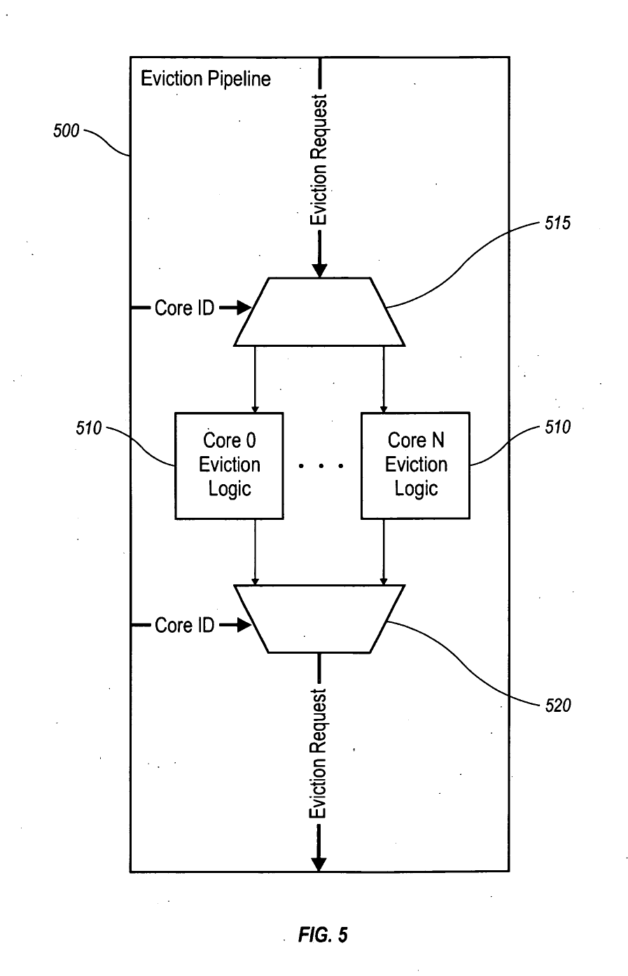

In at least one implementation, as illustrated in FIG. 2, a counter 200 can be communicatively coupled to each of the core processors 100. The counter 200 can be implemented to determine which cache lines of the respective corresponding partitioned cache memory 120 will be flushed or evicted. Such counters 200 can be implemented where the controller 125 is enabled to flush a partitioned cached 120 prior to powering down the partitioned cache memory 120 in response to the corresponding core processor 100 powering down. Further details as to the counter 200 and flushing cache lines of the partitioned cache 120 will be described in relation to FIG. 5.

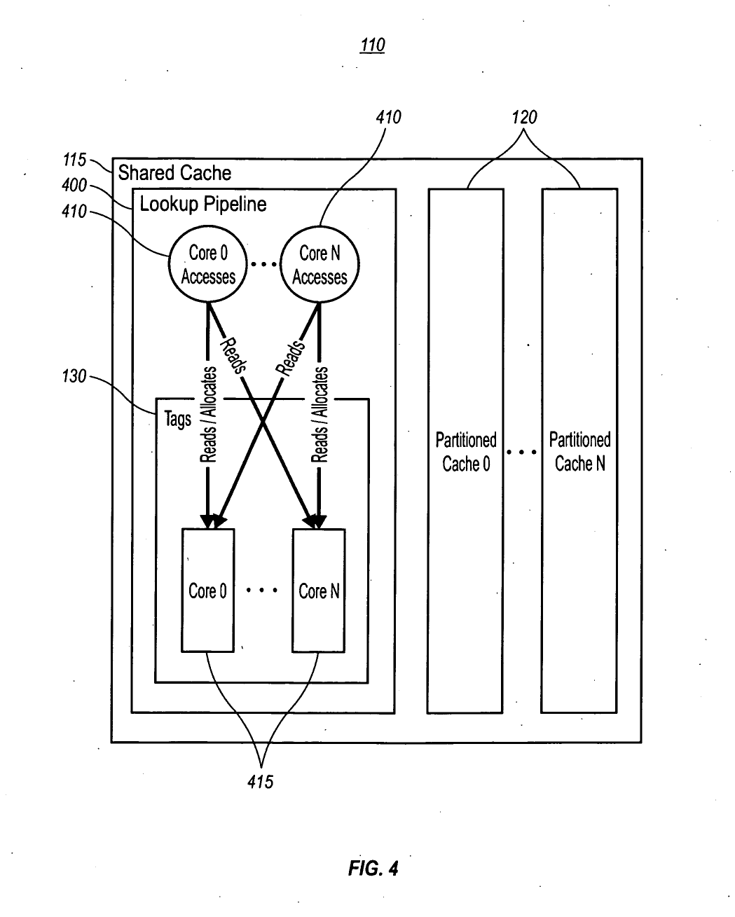

In the example implementation illustrated in FIG. 1, the cache memory 110 can also include a cache access module 130. The cache access module 130 can include a plurality of tags. The tags can be identifiers that provide the address of the partitioned cache 120 to which a core processor 100 can read, write, or allocate. In an alternative implementation, the cache access module 130 can include a lookup pipeline, as will be described in relation to FIGS. 4 and 5. While FIGS. 1-2 and 4-5 illustrate a cache access module 130, those of ordinary skill in the art will appreciate that the cache access module 130 can be optionally included.

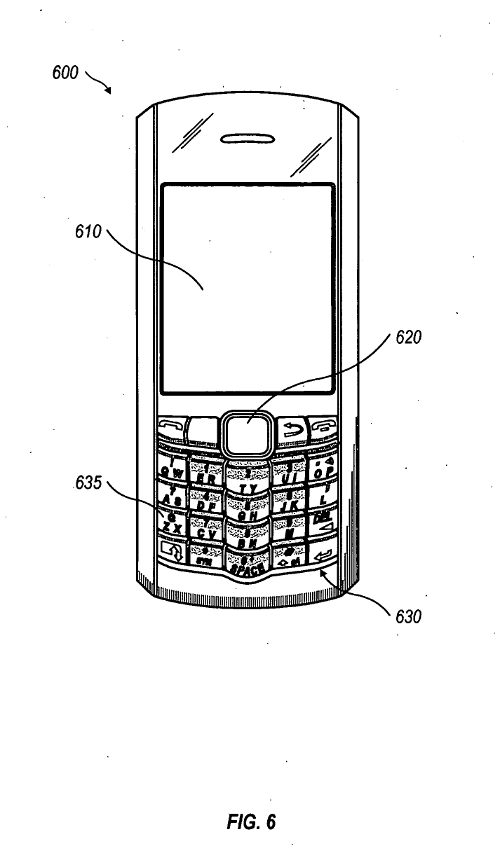

FIG. 3 is a flow chart of a method 300 for dynamically power scaling a cache memory of a multi-core processing system. The example method 300 is provided by way of example, as there are a variety of ways to carry out the method. Additionally, while the example method 300 is illustrated with a particular order of steps, those of ordinary skill in the art will appreciate that FIG. 3 is by way of example, and the steps illustrated therein can be executed in any order that accomplishes the technical advantages of the present technology described herein and can include fewer or more steps than as illustrated. The method 300 described below can be carried out using an electronic device and communication network as shown in FIG. 6 by way of example, and various elements of FIGS. 1-2 and 4-6 are referenced in explaining example method 300. Each block shown in FIG. 3 represents one or more processes, methods or subroutines, carried out in example method 300.

The example method 300 begins at block 305. At block 305, the method 300 can partition the cache memory 110 into a plurality of partitioned cache memory 120. For example, in at least one implementation, the shared cache memory 115 can be partitioned into a plurality of partitioned cache memory 120. Each partitioned cache 120 can be allocated to a corresponding core processor 100. In other words, each partitioned cache memory 120 is associated with a respective corresponding core processor 100.

As the shared cache memory 115 is partitioned into partitioned cache memory 120, and each partitioned cache memory 120 is allocated to a corresponding core processor 100, the method 300 proceeds to block 315. A block 315, a decision or determination is made whether a core processor 100 is powering down. For example, the decision or determination can be made by the controller 125. In at least one implementation, a core processor 100 can be powered down in response to the core processor 100 becoming idle or not being utilized to perform actions on an electronic device communicatively coupled to the core processor 100.

If a determination is made that a core processor 100 is powered down, the method 300 proceeds to block 320. At block 320, the respective partitioned cache memory 120, corresponding to the core processor 100 that is powered down, can also be powered down. For example, in at least one implementation, the controller 125 can power down the corresponding partitioned cache memory 120 in response to the corresponding core processor 100 powering down. By powering down the partitioned cache memory 120 associated with their respective corresponding core processors 100, a substantially large portion of the cache memory 110 can be powered down, thereby reducing the amount of power dissipation associated with the cache memory 110. In at least one implementation, prior to powering down the respective partitioned cache memory 120, the respective partitioned cache memory 120 can be flushed of data. In other words, the cache lines of the partitioned cache memory 120, on which data can be stored, can be erased when the partitioned cache memory 120 is powered down in response to the corresponding core processor 100 powering down. As only the cache lines associated with the partitioned cache memory 120 to be powered down are flushed, the partitioned cache can be powered down without losing any cache data which are stored on the other partitioned cache memory 120 or in the shared cache 115. Therefore, as only the core processors 100 and the portions of the cache memory 110 (the shared cache 115 and the partitioned cache 115) that are presently executing read and write functions are powered on, power is efficiently consumed by the multi-core system including the core processors 100 and the cache memory 110.

If a determination is made that a core processor 100 is not powering down, the method 300 proceeds to block 325. At block 325, a determination is made whether a read request (for example a request for a read action) has been received from a core processor 100. In at least one implementation, the read request can be made directly by the core processor 100; while in other example implementations, the read request can be made by the controller 125 or other intervening components communicatively coupled to the cache memory 110 and the core processor 100 requesting the read access.

If a read request is received, the method 300 proceeds to block 330. At block 330, the method 300 can enable a read access of the shared cache memory 115 and at least one partitioned cache 120 corresponding to a core processor 100 different from the core processor 100 that requested the read access. In at least one implementation, the controller 125 can enable the read access; however, in other example implementations, a cache access module 130 or other component communicatively coupled to the cache memory 110 and the core processors 100 can enable the read access. In at least one implementation, the core processor 100 can be enabled to read the data stored on the shared cache memory 115, the data stored the corresponding partitioned cache memory 120 associated with the core processor 100 executing the read action, and the data stored on a partitioned cached memory 120 associated with a different core processor. In another implementation, the core processor 100 can be enabled to read into the cache memory 110 and ignore the partitions of the partitioned cache memory 120, thereby making the cache memory 110 fully accessible. In such an implementation, the plurality of core processors 100 can share or read code and data without duplicating the cache lines for the shared code and data into each partitioned cache memory 120. Therefore, as shared code and data can be accessible by each of the core processors 100, the shared code and data need not be stored on each of the partitioned cache memory 120, thereby efficiently utilizing the cache lines of the partitioned cache memory 120 and efficiently utilizing the memory of an electronic device or a multi-core system. Furthermore, as the shared code and data are not duplicated on multiple partitioned cache memory, the power required to store the shared code and data is minimized.

If a read request has not been received from a core processor 100 at block 325, the method 300 proceeds to block 335. At block 335, a determination is made as to whether an allocate request has been received from a core processor 100. In at least one implementation, the allocate request can be a request by a processor to write to the cache memory 110 or to store data on the cache memory 110. The allocate request can be made directly by the core processor 100; while in other example implementations, the allocate request can be made by the controller 125 or other intervening components communicatively coupled to the cache memory 110 and the core processor 100 requesting the allocate access.

If an allocate request has been received, the method 300 proceeds to block 340. At block 340, the method can allocate to the respective partitioned cache memory 120 corresponding to the core processor 100 that requested the allocate request. The controller 125 can enable the allocate action to the respective cache memory 120; however, in other example implementations, the core processor 100 can be enabled to directly execute that allocate action, into the cache memory 110, the cache access module 130 can enable the allocate action, or any other component communicatively coupled to the core processor 100 and the respective cache memory 120 can enable the allocate action. The allocate action can be a write action. The write action can enable the core processor 100 requesting the allocate action to store or write data to a cache line of the respective partitioned cache memory 120. In at least one implementation, the core processor 100 can only allocate into its respective corresponding partitioned cache memory 120, the data stored on the other partitioned cache memory 120 and in the shared cache memory 120. will not be lost in the event the core processor 100 and the respective corresponding partitioned cache memory 120 are powered down. Therefore, the storage of the shared data of the cache memory 110 and the data belonging to other partitioned cache memory 120 are optimized and power is efficiently consumed as the partitioned cache 120 to be allocated to can remained powered on, while the core processors 100 and their corresponding partitioned cache 120 which will not be accessed can be powered down. Thus, in such an implementation of the method 300, only the necessary core processors 100 and portions of the cache memory 110 (for example, the shared cache 115 and the corresponding partitioned cache 120 that will be allocated to) can remain active and consume power. In the event an allocate request has not been received at block 335, the method 300 proceeds to block 315, block 325, or block 335, until a core processor powers down, a read request is received, or a write request is received.

FIG. 4 is an illustration of the logic path of the multi-core processing system in accordance with an example implementation of the present technology. In FIG. 4, the cache memory 110 is illustrated. The cache memory includes the shared cache 115. The shared cache 115 is partitioned into a plurality of partitioned cache 120. Each partitioned cache 120 corresponds to a corresponding core processor 100 (shown in FIGS. 1, 2 and 7). The cache memory 110 includes a lookup pipeline 400. The lookup pipeline 400 can receive and process the read and allocate requests requested 410 by the core processors. The lookup pipeline 400 can also include a tags database 130. The tags database 130 can include a plurality of tags. Each tag can be associated with a corresponding partitioned cache 120. For example, the tags can provide the addresses of the cache lines of the partitioned cache to which the core processors 100 can read or allocate.

In an example implementation of the multi-core processing system in accordance with an example implementation of the present technology, a core processor 100 can send a signal 410 to the cache memory 110 indicative of a request a read action of data stored on the cache memory 110. The lookup pipeline 400 can receive the request signal 410 and search the database of tags 130 to determine which partitioned cache memory to access. As the request 410 is a read action, the lookup pipeline 410 can determine that the core processor 100 can be associated with the tags 415 associated with any or all of the partitioned cache memory 120. As the core processor 100 can be associated with the tags 415 of any or all of the partitioned cache memory 120, the core processor 100 can read into any or all of the partitioned cache memory 120, including the respective corresponding cache memory as well as a partitioned cache memory corresponding to another core processor.

On the other hand, the core processor 100 can send a signal 410 to the cache memory 110 indicative of an allocate request to allocate data or code to the cache memory 110. In such an implementation, the lookup pipeline 400 can receive the request signal 410 and search the database of tags 130 to determine to which partitioned cache memory 120 the core processor 100 can allocate data or code. As illustrated in FIG. 4, the lookup pipeline 400 can associate the core processor 100 with only the tag 415 associated with the respective corresponding partitioned cache 415 “owned” by the core processor 100 that sent the request signal 410 to allocate code or data. Thus, when the allocate action is executed, the core processor 100 will only allocate to the respective corresponding partitioned cache 120. Therefore, as illustrated in FIG. 6, the lookup pipeline 400 illustrates that when a request 410 to read is received, the lookup pipeline will search the tags 415 of any or all of the partitioned cache memory; whereas, when a request 410 to allocate is received, the lookup pipeline 400 will only search for tags 415 corresponding to the respective corresponding cache memory 120 associated with the core processor 100 that sent the request 410 to allocate.

In at least one implementation, the tags 415 of the cache lines associated with the partitioned cache 120 can remain active when the partitioned cache 120 is powered down in response to the corresponding core processor 100 powering down. In at least one implementation, the tags 415 can remain powered on, even though the partitioned cache 120 and the corresponding core processor 100 are powered down. By maintaining the tags 415 active, the associations between the cache line addresses of the partitioned cache can still be searched by the core processors 100 that are not powered down. Thus, while the partitioned cache 120 can be powered down, the tags 415 associated therewith can remain active and remain accessible by other core processors 100. Furthermore, maintaining the tags 415 active can simplify the hardware logic implementation. In at least one implementation, if all of the tags 415 remain powered, and one or more partition cache memory 120 are powered down, then the lookups of the tags associated with those partitioned cache memory 120 will produce a miss, and the hardware can continue to process the logic needed in processing read and allocate actions to the cache memory 110.

As discussed above, in at least one implementation, prior to powering down a partitioned cache memory 120 in response to the corresponding core processor 100 powering down, the partitioned cache memory 120 can be flushed. For example, data stored in the partitioned cache memory 120 can be evicted or erased. FIG. 5 illustrates example logic the system can execute in the even a partitioned cache memory 120 is to be flushed. For example, the logic illustrated in FIG. 5 can be executed by the pipeline 400 illustrated in FIG. 4 and can be implemented with the counters 200 illustrated in FIG. 2. FIG. 5 illustrates example logic executed by the system to determine which cache lines will be flushed out. In at least implementation, a core processor 100 can be powered down, and the controller 125 can determine that the respective corresponding partitioned cache 120 will also be powered down. However, prior to powering down the partitioned cache 120, the controller 125 can request or access an eviction pipeline 500 as illustrated in FIG. 5 to evict data stored on the partitioned cache 120 to be powered down. The request to evict data can be received by the eviction pipeline 500 and processed by loop. The loop can initiate a start 515 to search eviction logic 510 associated with each of the core processors 100. The eviction logic 510 can provide instructions to determine which cache lines of the partitioned cache 120 to be powered down will be flushed before the partitioned cache 120 is power down. For example, the logic 510 can be a round robin replacement policy. In the round robin replacement policy, a counter 200 can be set to identify which cache lines of the partitioned cache 120 have been written to or allocated to by the corresponding core processor 100 and to identify the recency of when the cache lines had been written or allocated. If the counter 200 indicates the data written or allocated to the cache line is stale, the eviction logic 510 proceeds to a stop 520 of the loop. When the loop is stopped, a determination of the cache line of the partitioned cache memory 120 to be flushed has been made. The eviction pipeline 500 can then evict the data stored in the cache line to a main memory or can erase the data stored in the cache line. The cache line of the partitioned cache memory 120 is then clean and can be written or allocated. For example, prior to powering down the partitioned cache memory 120 in response to the corresponding core processor 100 powering down, some or all of the cache lines of the partitioned cache memory 120 can be evicted. Thus, when the core processor 100 is powered up and the partitioned cache memory 120 is powered up, the cache lines are clean and can be written or allocated to. However, in other example implementations, none of the cache lines of the partitioned cache memory 120 to be powered down can be evicted; in such an implementation, the eviction of the cache lines can be performed by another replacement policy, for example a least recently used (LRU) policy.

FIG. 6 illustrates an electronic device in which the multi-core processing system in accordance with an example implementation of the present technology. The illustrated electronic device is a mobile communication device 100. The mobile communicative device includes a display screen 610, a navigational tool (auxiliary input) 620 and a keyboard 630 including a plurality of keys 635 suitable for accommodating textual input. The electronic device 600 of FIG. 1 can be a unibody construction, but common “clamshell” or “flip-phone” constructions are also suitable for the implementations disclosed herein. While the illustrated electronic device 100 is a mobile communication device 100, those of ordinary skill in the art will appreciate that the electronic device 100 can be a computing device, a portable computer, an electronic pad, an electronic tablet, a portable music player, a portable video player, or any other electronic device 100 in which a multi-core processing system can be implemented.

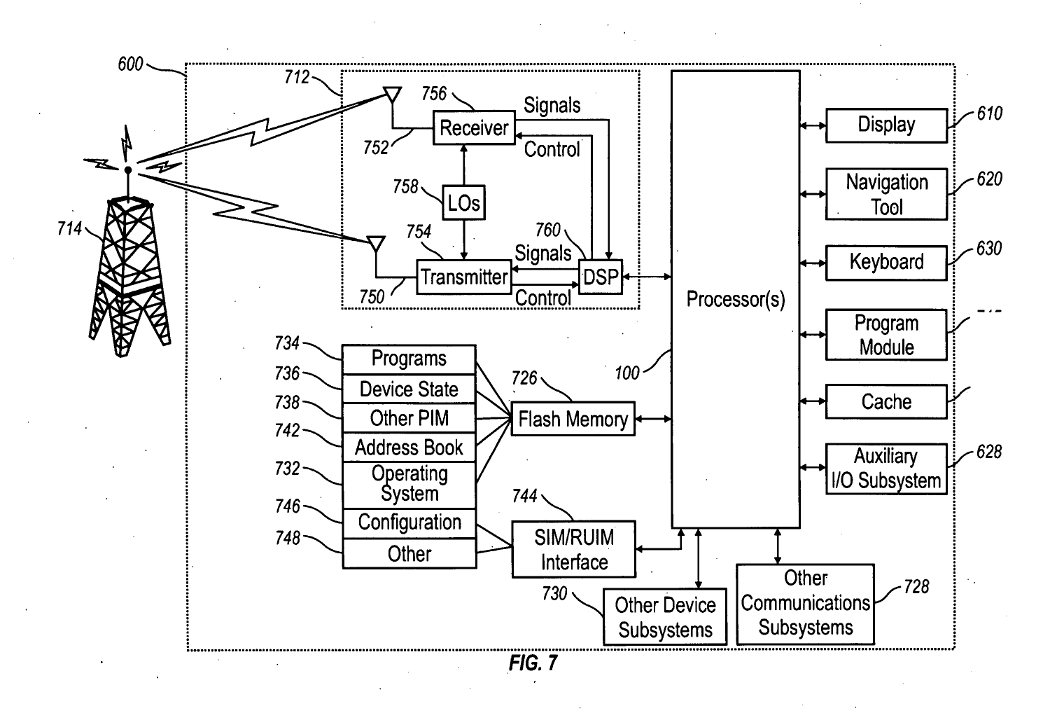

Referring to FIG. 7, a block diagram representing an electronic device 100 interacting in a communication network in accordance with an example implementation is illustrated. As shown, the electronic device 100 can include a multi-core processor system comprising a plurality of core processors 100 (hereinafter a “processor”) that control the operation of the electronic device 600. A communication subsystem 712 can perform all communication transmission and reception with the wireless network 714. The processor 100 can be communicatively coupled to an auxiliary input/output (I/O) subsystem 628 which can be communicatively coupled to the electronic device 100. A display 610 can be communicatively coupled to processor 100 to display information to an operator of the electronic device 600. When the electronic device 600 is equipped with a keyboard 630, which can be physical or virtual, the keyboard 630 can be communicatively coupled to the processor 100. The electronic device 600 can include a speaker, a microphone, a cache memory 110, all of which can be communicatively coupled to the processor 100.

The electronic device 600 can include other similar components that are optionally communicatively coupled to the processor 100. Other communication subsystems 728 and other device subsystems 730 can be generally indicated as being communicatively coupled to the processor 100. An example other communication subsystem 728 is a short range communication system such as BLUETOOTH® communication module or a WI-FI® communication module (a communication module in compliance with IEEE 802.11b). These subsystems 728, 730 and their associated circuits and components can be communicatively coupled to the processor 100. Additionally, the processor 100 can perform operating system functions and can enable execution of programs on the electronic device 600. In some implementations the electronic device 600 does not include all of the above components. For example, in at least one implementation, the keyboard 630 is not provided as a separate component and can be integrated with a touch-sensitive display 610 as described below.

Furthermore, the electronic device 600 can be equipped with components to enable operation of various programs. In an example implementations, the flash memory 726 can be enabled to provide a storage location for the operating system 732, device programs 734, and data. The operating system 732 can be generally configured to manage other programs 734 that are also stored in memory 726 and executable on the processor 100. The operating system 732 can honor requests for services made by programs 734 through predefined program interfaces. More specifically, the operating system 732 can determine the order in which multiple programs 734 are executed on the processor 100 and the execution time allotted for each program 734, manages the sharing of memory 726 among multiple programs 734, handles input and output to and from other device subsystems 730, and so on. In addition, operators can typically interact directly with the operating system 732 through a user interface usually including the display screen 610 and keyboard 630. While in an example implementation, the operating system 732 can be stored in flash memory 726, the operating system 732 in other implementations is stored in read-only memory (ROM) or similar storage element 110. As those skilled in the art will appreciate, the operating system 732, device program 734 or parts thereof can be loaded in RAM or other volatile memory. In one example implementation, the flash memory 726 can contain programs 734 for execution on the electronic device 600 including an address book 742, a personal information manager (PIM) 738, and the device state 736. Furthermore, programs 734 and other information 748 including data can be segregated upon storage in the flash memory 726 of the electronic device 600.

When the electronic device 600 is enabled for two-way communication within the wireless communication network 714, the electronic device 600 can send and receives signal from a mobile communication service. Examples of communication systems enabled for two-way communication can include, but are not limited to, the General Packet Radio Service (GPRS) network, the Universal Mobile Telecommunication Service (UMTS) network, the Enhanced Data for Global Evolution (EDGE) network, the Code Division Multiple Access (CDMA) network, High-Speed Packet Access (HSPA) networks, Universal Mobile Telecommunication Service Time Division Duplexing (UMTS-TDD), Ultra Mobile Broadband (UMB) networks, Worldwide Interoperability for Microwave Access (WiMAX), and other networks that can be used for data and voice, or just data or voice. For the systems listed above, the electronic device 600 can require a unique identifier to enable the electronic device 600 to transmit and receive signals from the communication network 714. Other systems may not require such identifying information. GPRS, UMTS, and EDGE use a Subscriber Identity Module (SIM) in order to allow communication with the communication network 714. Likewise, most CDMA systems can use a Removable User Identity Module (RUIM) in order to communicate with the CDMA network. The RUIM and SIM card can be used in a multitude of different mobile devices 100. The electronic device 600 can operate some features without a SIM/RUIM card, but a SIM/RUIM card is necessary for communication with the network 714. A SIM/RUIM interface 744 located within the electronic device 600 can allow for removal or insertion of a SIM/RUIM card (not shown). The SIM/RUIM card can feature memory and holds key configurations 746, and other information 748 such as identification and subscriber related information. With a properly enabled electronic device 600, two-way communication between the electronic device 600 and communication network 714 can be possible.

If the electronic device 600 is enabled as described above or the communication network 714 does not require such enablement, the two-way communication enabled electronic device 600 is able to both transmit and receive information from the communication network 714. The transfer of communication can be from the electronic device 600 or to the electronic device 600. In order to communicate with the communication network 714, the electronic device 600 in the presently described example implementation can be equipped with an integral or internal antenna 752 for transmitting signals to the communication network 714. Likewise the electronic device 600 in the presently described example implementation can be equipped with another antenna 752 for receiving communication from the communication network 714. These antennae (752, 750) in another example implementation can be combined into a single antenna (not shown). As one skilled in the art would appreciate, the antenna or antennae (752, 750) in another implementation can be externally mounted on the electronic device 600.

When equipped for two-way communication, the electronic device 600 can include a communication subsystem 712. As is understood in the art, this communication subsystem 712 can support the operational needs of the electronic device 600. The subsystem 712 can include a transmitter 754 and receiver 756 including the associated antenna or antennae (752, 750) as described above, local oscillators (LOs) 758, and a processing module 760 which in the presently described example implementation can be a digital signal processor (DSP) 760.

Communication by the electronic device 600 with the wireless network 714 can be any type of communication that both the wireless network 714 and electronic device 600 are enabled to transmit, receive and process. In general, these can be classified as voice and data. Voice communication generally refers to communication in which signals for audible sounds are transmitted by the electronic device 600 through the communication network 714. Data generally refers to all other types of communication that the electronic device 600 is capable of performing within the constraints of the wireless network 714.

While the above description generally describes the systems and components associated with a handheld mobile device, the electronic device 600 can be another communication device such as a PDA, a laptop computer, desktop computer, a server, or other communication device. In those implementations, different components of the above system might be omitted in order provide the desired electronic device 600. Additionally, other components not described above may be required to allow the electronic device 600 to function in a desired fashion. The above description provides only general components and additional components can be required to enable system functionality. These systems and components would be appreciated by those of ordinary skill in the art.

Those of skill in the art will appreciate that other implementations of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Implementations may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Furthermore, the present technology can take the form of a computer program product including program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums as signal carriers per se are not included in the definition of physical computer-readable medium). Examples of a physical computer-readable medium include a semiconductor or solid state memory, removable memory connected via USB, magnetic tape, a removable computer diskette, a random access memory (RAM), a read-only memory (ROM), a rigid magnetic disk, an optical disk, and non-transitory memory. Current examples of optical disks include compact disk-read only memory (CD-ROM), compact disk-read/write (CD-R/W), DVD, and Blu Ray™.

Implementations within the scope of the present disclosure may also include tangible and/or non-transitory computer-readable storage media for carrying or having computer-executable instructions or data structures stored thereon. Additionally, non-transitory memory also can store programs, device state, various user information, one or more operating systems, device configuration data, and other data that may need to be accessed persistently. Further, non-transitory computer-readable storage media expressly exclude media such as energy, carrier signals, electromagnetic waves, and signals per se. Such non-transitory computer-readable storage media can be any available media that can be accessed by a general purpose or special purpose computer, including the functional design of any special purpose processor as discussed above. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media. Both processors and program code for implementing each medium as an aspect of the technology can be centralized or distributed (or a combination thereof) as known to those skilled in the art.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

A data processing system suitable for storing a computer program product of the present technology and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem, Wi-Fi, and Ethernet cards are just a few of the currently available types of network adapters. Such systems can be centralized or distributed, e.g., in peer-to-peer and client/server configurations. In some implementations, the data processing system is implemented using one or both of FPGAs and ASICs.

Example implementations have been described hereinabove regarding the implementation of a method and system for dynamically power scaling a cache memory of a multi-core processing system. One of ordinary skill in the art will appreciate that the features in each of the figures described herein can be combined with one another and arranged to achieve the described benefits of the presently disclosed method and system for dynamically power scaling a cache memory of a multi-core processing system. Additionally, one of ordinary skill will appreciate that the elements and features from the illustrated implementations herein can be optionally included to achieve the described benefits of the presently disclosed method and system for dynamically power scaling a cache memory of a multi-core processing system. Various modifications to and departures from the disclosed implementations will occur to those having skill in the art. The subject matter that is intended to be within the scope of this disclosure is set forth in the following claims.

1. An electronic device comprising:
a plurality of core processors;
cache memory comprising partitioned cache and shared cache, with each core processor communicatively coupled to at least one corresponding partitioned cache and the shared cache; and
a controller communicatively coupled to each of the core processors, to the partitioned cache, and to the shared cache, the controller configured to cause the at least one corresponding partitioned cache to power down in response to the corresponding core processor powering down.

2. The electronic device as recited in claim 1, wherein the partitioned cache is a portion of the shared cache.

3. The electronic device as recited in claim 1, wherein the controller comprises a plurality of controllers and each controller is communicatively coupled to a corresponding core processor.

4. The electronic device as recited in claim 1, further comprising a lookup pipeline communicatively coupled to the controller and the cache memory, wherein the controller is further configured to access the lookup pipeline to determine an address for at least one of a read action and a write action.

5. The electronic device as recited in claim 1, wherein the address for the read action includes the shared cache and at least one partitioned cache.

6. The electronic device as recited in claim 1, wherein one of the core processors is a requesting core processor, and wherein in response to a read request signal generated by the requesting core processor, the controller is configured to enable a read action of the partitioned cache of the corresponding core processor different from the requesting core processor.

7. The electronic device as recited in claim 1, wherein the controller is further configured to flush the partitioned cache to powering down the partitioned cache.

8. The electronic device as recited in claim 1, further comprising a cache access module stored in the cache memory, wherein the core processor is configured to access the cache access module to determine an address for at least one of a read action and write action

9. The electronic device as recited in claim 8, wherein the cache access module comprises a lookup pipeline, the lookup pipeline comprising a plurality of addresses, each address associated with one of the partitioned cache.

10. The electronic device as recited in claim 8, wherein:
the cache access module comprises plurality of tags, each tag associated with a corresponding partitioned cache; and
the controller is further configured to flush the corresponding partitioned cache prior to powering down the corresponding partitioned cache while maintaining the tag associated with the corresponding partitioned cache active.

11. The electronic device as recited in claim 1, wherein each core processor is adapted to enable an allocate action to a new cache line of only the respective corresponding partitioned cache.

12. The electronic device as recited in claim 11, wherein each processor is adapted to enable a read action into at least two of the partitioned cache.

13. The electronic device as recited in claim 1,
wherein each partitioned cache comprises a plurality of cache lines to which the corresponding core processor allocates; and
further comprising a plurality of counters, each counter corresponding to a corresponding one of the plurality of core processors and configured to determine one of the plurality of cache lines of the corresponding partitioned cache for flushing.

14. A controller for power scaling a plurality of core processors and cache memory, the cache memory comprising partitioned cache and shared cache, with each core processor communicatively coupled to at least one corresponding partitioned cache and the shared cache, the controller comprising:
a computer readable medium communicatively coupled to one of the core processors and the partitioned cache; and
a program module stored on the computer readable medium, and operable, upon execution by one of the plurality of core processors to cause the at least one corresponding partitioned cache to power down in response to the corresponding core processor powering down.

15. The controller of claim 14, wherein the program module is further operable upon execution by one of the plurality of core processors to enable the core processor to allocate to the corresponding partitioned cache.

16. The controller as recited in claim 14, wherein the program module is further operable upon execution by one of the plurality of core processors to enable the core processor to read the shared cache.

17. The controller as recited in claim 14, wherein the program module is further operable upon execution by one of the plurality of core processors to enable the core processor to read at least one partitioned cache corresponding to a different core processor.

18. The controller as recited in claim 14, wherein the program module is further operable upon execution by one of the plurality of core processors to flush partitioned cache prior to powering down the partitioned cache.

19. The controller as recited in claim 14, further comprising a plurality of counters, each counter corresponding to a corresponding one of the plurality of core processors, the counter configured to determine a cache line of the corresponding partitioned cache for flushing.

20. A method for managing a cache memory for a multi-core processor system comprising a plurality of core processors, the method comprising:
partitioning the cache memory into a plurality of partitioned cache memory;
allocating each partitioned cache memory to a corresponding core processor of a plurality of core processors; and
powering down one of the partitioned cache memory in response to the corresponding core processor powering down.

21. The method of claim 20 further comprising enabling a flush of one of the partitioned cache memory prior to powering down the partitioned cache memory.

22. The method as recited in claim 20 further comprising enabling replacement of a cache line of the partitioned cache memory by only the corresponding core processor.

23. The method as recited in claim 20 further comprising enabling a read access by a core processor to read from the partitioned cache memory associated with another core processor of the plurality of core processors.

24. The method as recited in claim 20, wherein allocating each partitioned cache memory comprises enabling a write action to one of the plurality of partitioned cache memory by only the corresponding core processor.
